(19) United States
(12) Patent Application Publication
(10) Pub. No.: US 2016/0125330 A1
(43) Pub. Date: May 5, 2016

(54) ROLLING UPGRADE OF METRIC COLLECTION AND AGGREGATION SYSTEM

(71) Applicant: AppDynamics, Inc., San Francisco, CA (US)

(72) Inventor: Guatam Borah, San Francisco, CA (US)

(21) Appl. No.: 14/530,454

(22) Filed: Oct. 31, 2014

(51) Int. Cl. G06Q 10/06

(52) U.S. Cl. CPC G06Q 10/0633; G06Q 10/067

(57) ABSTRACT

A system processes a large volume of real time hierarchical system metrics using distributed computing by stateless processes. The metrics processing system receives different types of hierarchical metrics coming from different sources and then aggregates the metrics by their hierarchy. The system is on-demand, cloud based, multi-tenant and highly available. The system makes the aggregated metrics available for reporting and policy triggers in real time. The aggregators and collectors may be upgraded to new versions with minimal loss in data.

### BACKGROUND OF THE INVENTION

The World Wide Web has expanded to make various services available to the consumer as online web application. A multi tiered web application is comprises of several internal or external services working together to provide a business solution. These services are distributed over several machines or nodes, creating an n-tiered, clustered on-demand business application. The performance of a business application is determined by the execution time of a business transaction; a business transaction is an operation that completes a business task for end users of the application. A business transaction in an n-tiered web application may start at one service and complete in another service involving several different server machines or nodes. For Example, reserving a flight ticket involves a typical business transaction “checkout” which involves shopping-cart management, calling invoicing and billing system etc., involving several services hosted by the application on multiple server machines or nodes. It is essential to monitor and measure a business application to provide insight regarding bottlenecks in communication, communication failures and other information regarding performance of the services that provide the business application.

A business application is monitored by collecting several metrics from each server machine or node in the system. The collected metrics are aggregated by service or tier level and then again aggregated by the entire application level. The metric processing involves aggregation of hierarchical metrics by several levels for an n-tier business application. In a large business application environment hundreds and thousands of server machines or nodes create multiple services or tiers, each of these nodes generate millions of metrics per minute.

In the Appdynamics metric processing platform, metrics are aggregated in two stages—collection and aggregation. The collection of metrics are done at collector nodes, these collector nodes are service processes that collects metrics coming from all the sources at the lowest hierarchical level. Collectors send metrics to the second stage for further aggregation by their hierarchy, based on certain topology defined in the metric processing platform. The second stage of aggregation is done at independent service layers called aggregators. The collectors receive metrics in real time and send them to the aggregators continuously, at any given point of time if a aggregator node is shutdown, there would be a break in the metric aggregation pipeline and would create data inconsistency. Occasionally, the collector and aggregator nodes needs to be upgraded to newer version of the software, during these software upgrades there should not be any break in the service and also no data loss.

### SUMMARY OF THE CLAIMED INVENTION

The present technology processes a large volume of real time hierarchical system metrics using distributed computing by stateless processes. The metrics processing system receives different types of hierarchical metrics coming from different sources and then aggregates the metrics by their hierarchy. The system is on-demand, cloud based, multi-tenant and highly available. The system makes the aggregated metrics available for reporting and policy triggers in real time.

The metrics aggregation system involves two different classes of stateless java programs, collectors and aggregators, that work in tandem to receive, aggregate and roll up the incoming metrics. The aggregators and collectors may be upgraded to new versions without loss of data or break in the service.

An embodiment may include a method for processing metrics. A payload is received which includes sets of data. A hash from each set of data is then generated. Each data set may be transmitted to one of a plurality of aggregators based on the hash. Received metrics are then aggregated by each of a plurality of aggregators.

An embodiment may include a system for monitoring a business transaction. The system may include a processor, a memory and one or more modules stored in memory and executable by the processor. When executed, the one or more modules may receive a payload which includes sets of data, generate a hash from each set of data, transmit each data set to one of a plurality of aggregators based on the hash, and aggregate received metrics by each of a plurality of aggregators.

### BRIEF DESCRIPTION OF THE DRAWINGS

FIG. 1 is a block diagram of a system for aggregating data.

FIG. 2 is a block diagram of a collector and aggregator.

FIG. 3 is a block diagram of a collector and aggregator with upgraded aggregators.

FIG. 4 is a method for collecting and aggregating metrics.

FIG. 4 is a method for checking previous payload processing.

FIG. 5 is a method for upgrading an aggregator.

FIG. 6 illustrates a hierarchical tree of aggregator versions and aggregator identifiers.

FIG. 7 is a method for upgrading a collector.

FIG. 8 is a block diagram of a system for implementing the present technology.

### DETAILED DESCRIPTION

The present technology processes a large volume of real time hierarchical system metrics using distributed computing by stateless processes. The metrics processing system receives different types of hierarchical metrics coming from different sources and then aggregates the metrics by their hierarchy. The system is on-demand, cloud based, multi-tenant and highly available. The system makes the aggregated metrics available for reporting and policy triggers in real time.

The metrics aggregation system involves two different classes of stateless java programs, collectors and aggregators, that work in tandem to receive, aggregate and roll up the incoming metrics. The aggregators and collectors may be upgraded to new versions with minimal loss in data.

The method involves a collector process and an aggregators process. The first class of java processes, collectors, are stateless java programs. Multiple numbers of these collector programs could be instantiated depending on the incoming metrics load. The collector processes may receive the incoming metric traffic through a load balancer mechanism. Once the metrics are received, collector processes save the metrics in a persistence store and then based on a universal hashing algorithm routes metrics to specific aggregator nodes.

The second class of stateless java processes, aggregators, are arranged in a consistent hash ring using the same universal hash function. This may ensure a metric will be routed to the same aggregator node from any collector node.

Both collectors and aggregators may be upgraded without significant loss of data. An upgrade to aggregators may involve providing the upgraded aggregators along with the previous aggregators for an overlapping period of time. Once the period of time is over, metrics intended to be handled by the previous aggregators are discarded. Upgrades to collectors involve disconnecting the collectors from a source of metric packages, cleaning out the collector queue, and replacing the collector.

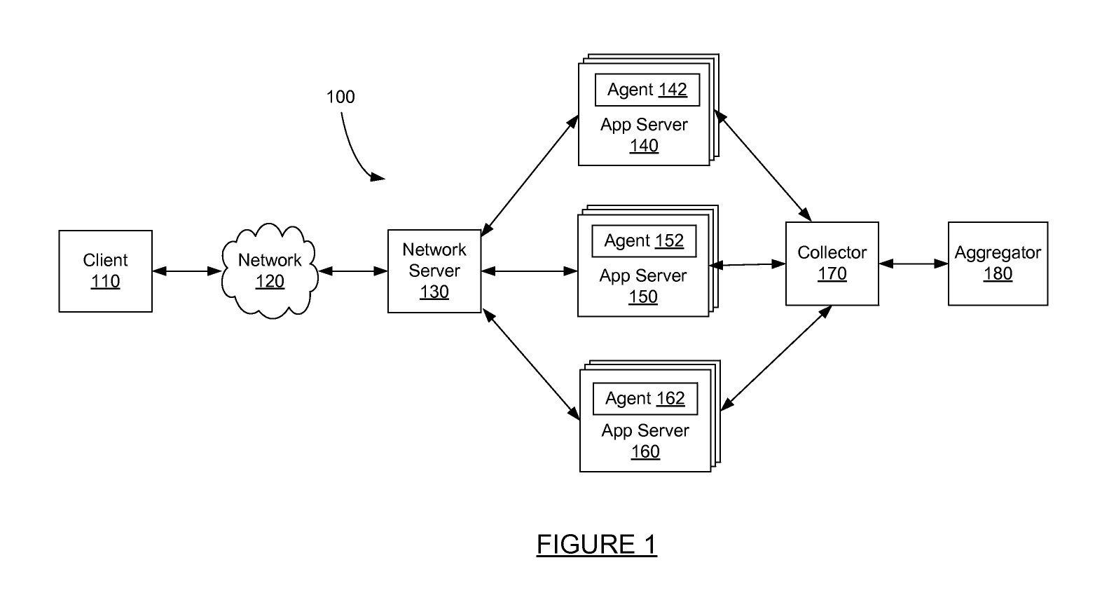

FIG. 1 is a block diagram of a system for aggregating data. The system of FIG. 1 includes client 110, network server 130, application servers 140, 150 and 160, collector 170 and aggregator 180. Client 110 may send requests to and receive responses from network server 130 over network 120. In some embodiments, network server 130 may receive a request, process a portion of the request and send portions of the request to one or more application servers 140-150. Application server 140 includes agent 142. Agent 142 may execute on application server 140 and monitor one or more functions, programs, modules, applications, or other code on application server 140. Agent 142 may transmit data associated with the monitored code to a collector 170. Application servers 150 and 160 include agents 152 and 162, respectively, and also transmit data to collector 170. More detail for a system that monitors distributed business transactions and reports data to be collected and aggregated is disclosed in U.S. patent application Ser. No. 12/878,919, titled “Monitoring Distributed Web Application Transactions,” filed Sep. 9, 2014, the disclosure of which is incorporated herein by reference.

Collector 170 may receive metric data and provide the metric data to one or more aggregators 180. Collector 170 may include one or more collector machines, each of which using a logic to transmit metric data to an aggregator 180 for aggregation. Aggregator 180 aggregates data and provides the data to a cache for reports to external machines. The aggregators may operation in a ring, receiving metric data according to logic that routes the data to a specific aggregator. Each aggregator may, in some instances, register itself with a presence server.

More details for collecting and aggregating metrics using a collector and aggregator is discussed in U.S. patent application Ser. No. 14/448,977, titled “Collection and Aggregation of Large Volume of Metrics, filed on Jul. 31, 2014, the disclosure of which is incorporated herein by reference.

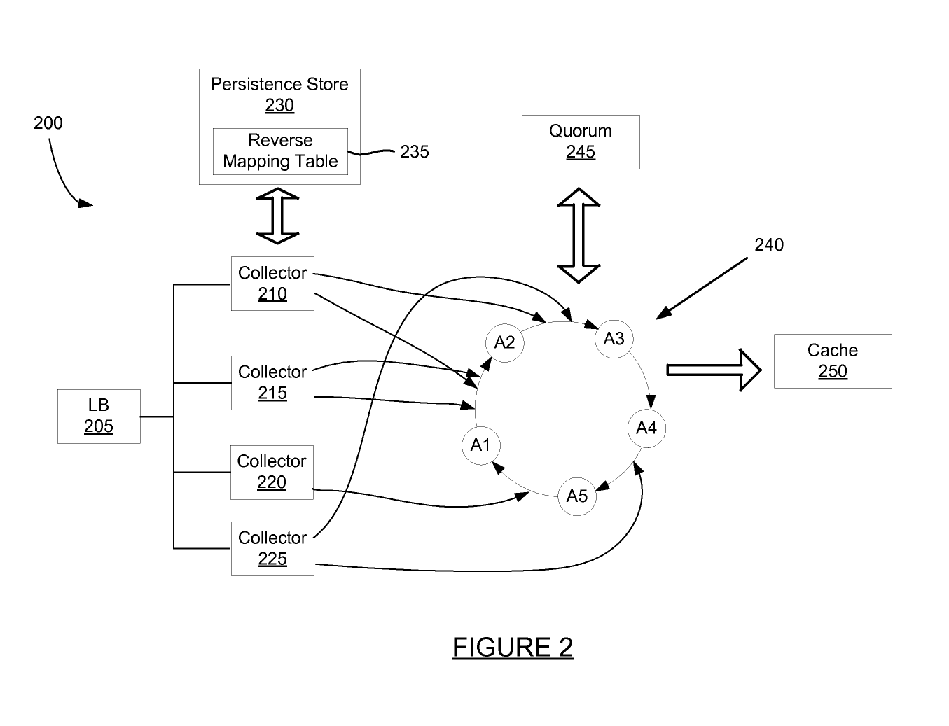

FIG. 2 is a block diagram of a collector and aggregator. The system of FIG. 2 includes load balancer 205, collectors 210, 215, 220 and 225, a persistence store 235, and aggregators 240 (A1-A5). The system of FIG. 2 also includes quorum 245 and cache 250. Agents on application servers may transmit metric data to collectors 210-225 through load balance machine 205. In some embodiments, the metrics are sent from the agent to a collector in a table format for example once per minute.

The collectors receive the metrics and use logic to route the metrics to aggregators. The logic may include determining a value based on information associated with the metric, such as a metric identifier. In some instances, the logic may include performing a hash on the metric ID. The metric may be forwarded to the aggregator based on the outcome of the hash of the metric ID. The same hash is used by each and every collector to ensure that the same metrics are provided to the same aggregator.

The collectors may each register with quorum 245 when they start up. In this manner, the quorum may determine when one or more collectors is not performing well and/or fails to register.

A persistence store stores metric data provided from the collectors to the aggregators. A reverse mapping table may be used to associate data with a metric such that when an aggregator fails, the reverse mapping table may be used to replenish a new aggregator with data associated with the metrics that it will receive.

Each aggregator may receive one or more metric types, for example two or three metrics. The metric information may include a sum, count, minimum, and maximum value for the particular metric. An aggregator may receive metrics having a range of hash values. The same metric type will have the same hash value and be routed to the same aggregator. An aggregator may become a coordinator. A coordinator may check quorum data and confirm persistence was successful.

Once aggregated, the aggregated data is provided to a cache 250. Aggregated metric data may be stored in cache 250 for a period of time and may eventually be flushed out. For example, data may be stored in cache 250 for a period of eight hours. After this period of time, the data may be overwritten with additional data.

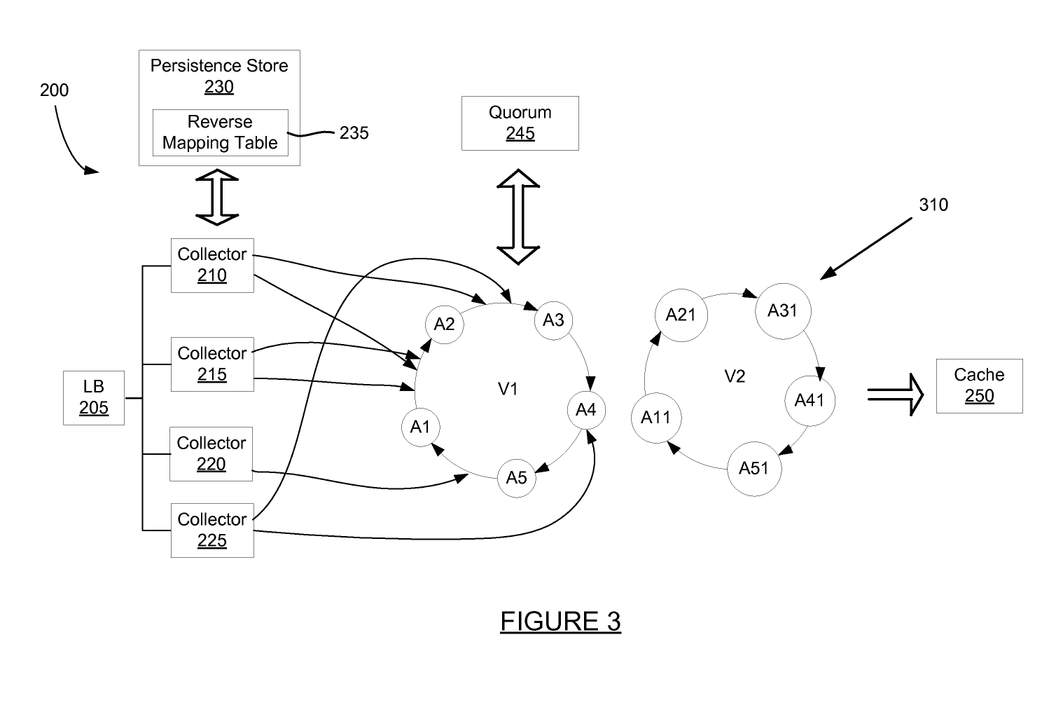

FIG. 3 is a block diagram of an aggregator and a collector with upgraded collectors. The aggregators and collectors of FIG. 3 are similar to that of FIG. 2 except that there is a second ring of aggregators 310. The second ring of aggregators includes aggregators which may correspond to an upgraded version “V2” of aggregators. The present technology provides a system and method for switching over to the newest version of aggregators while minimizing data loss.

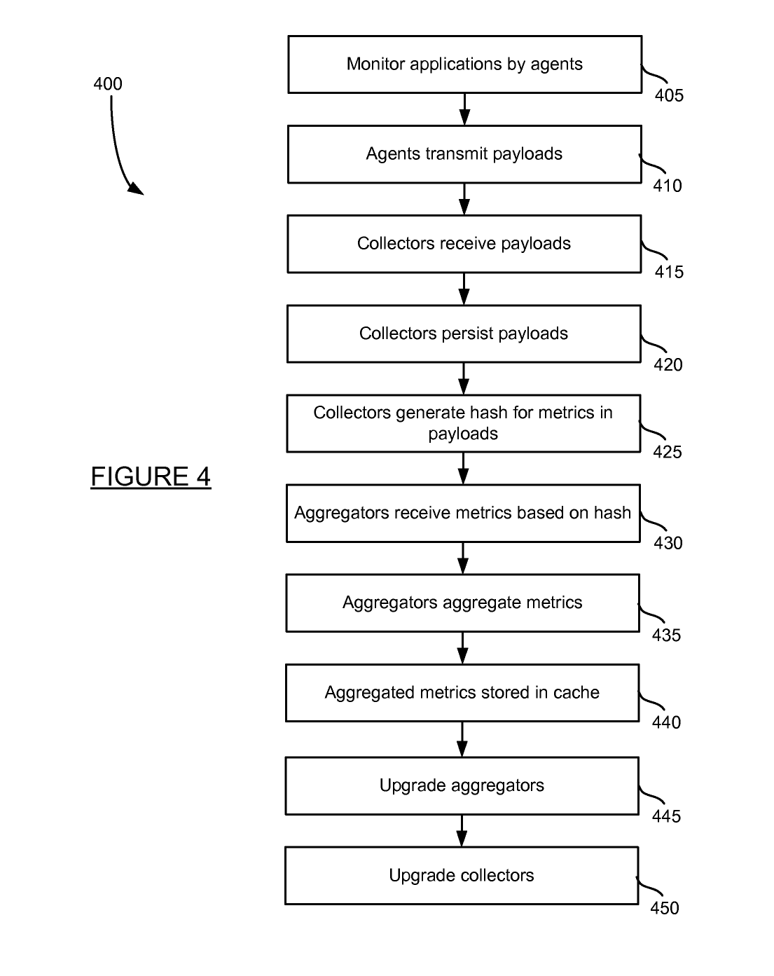

FIG. 4 is a method for collecting and aggregating metrics. First, applications are monitored by agents at step 405. The agents may collect information from applications and generate metric data. The agents may then transmit payloads to one or more collectors at step 410. The payloads may include metric information associated with the applications and other code being monitored by the particular agent. The payloads may be sent periodically from a plurality of agents to one or more collectors.

One or more collectors may receive the payloads at step 415. In some embodiments, a collector may receive an entire payload from an agent. The collectors persist the payload at step 420. To persist the payload, a collector may transmit the payload to a persistence store 230.

A collector may generate a hash for metric data within the payload at step 425. For example, for each metric, the collector may perform a hash on the metric type to determine a hash value. The hash same hash is performed on each metric by each of the one or more collectors. The metrics may then be transmitted by the collectors to a particular aggregator based on the hash value. Forwarding metric data to a particular aggregator of a plurality of aggregator is an example of the consistent logic that may be used to route metric data to a number of aggregators. Other logic to process the metric data may be used as well as long as it is the same logic applied to each and every metric.

The aggregators receive the metrics based on the hash value at step 430. For example, each aggregator may receive metrics having a particular range of hash values, the next aggregator may receive metrics having a neighboring range of hash values, and so on until a ring is formed by the aggregators to handle all possible hash values.

The aggregators then aggregate the metrics at step 435. The metrics may be aggregated to determine the total number of metrics, a maximum, a minimum, and average value of the metric. The aggregated metrics may then be stored in a cache at step 440. A controller or other entity may retrieve the aggregated metrics from the cache for a limited period of time.

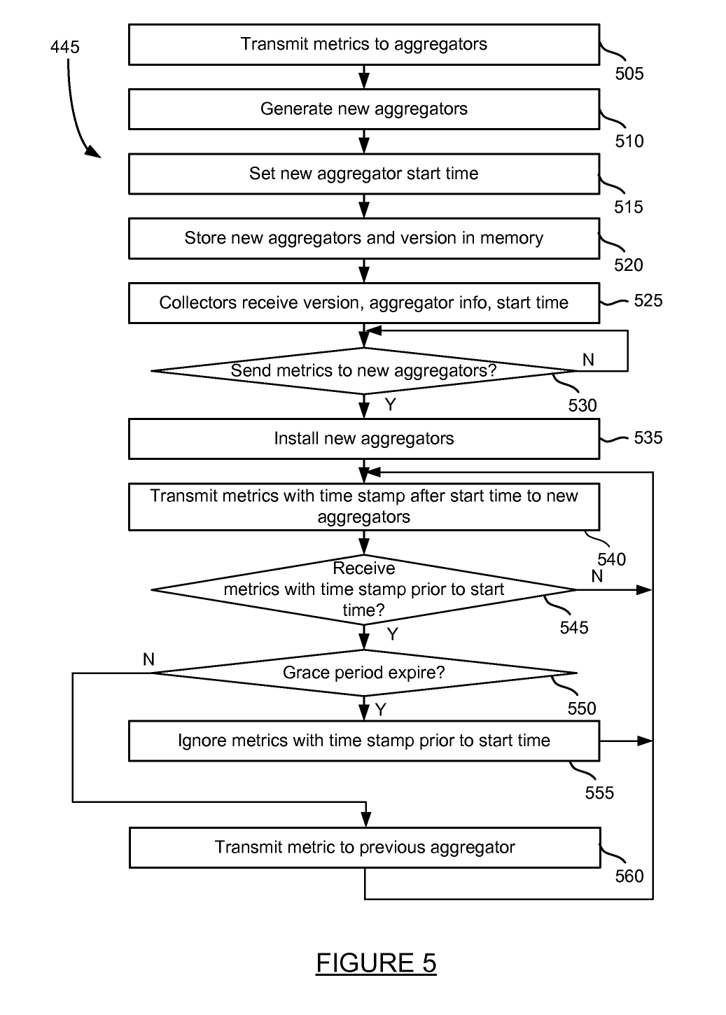

One or more aggregators may be updated at step 445. The aggregators are updated in a way such that minimal data is lost as a result of the upgrade. The aggregator upgrade involves allowing data to be transmitted to the prior version of aggregators or updated version of aggregators concurrently for a period of time. This overlapping period of time, or grace period, may be configured by an administrator. More details for upgrading an aggregator are discussed with respect to the method of FIG. 5.

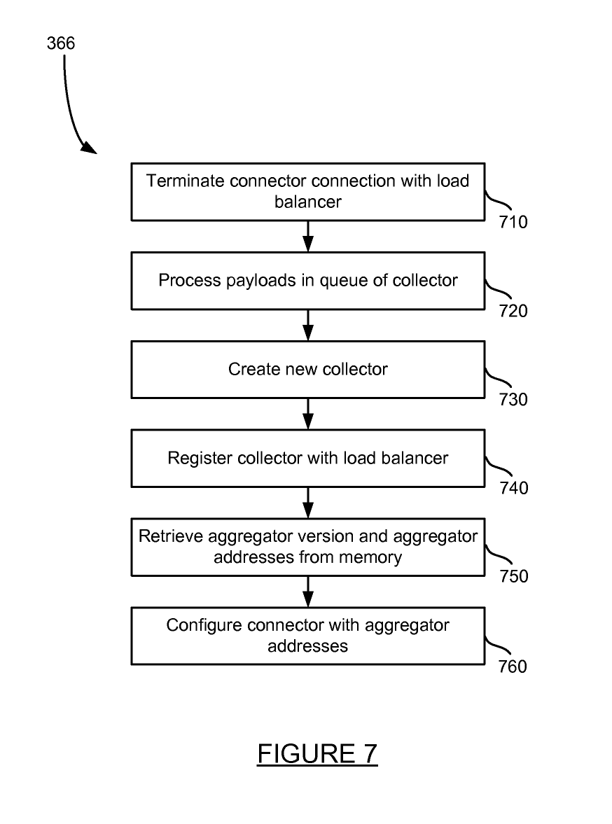

One or more collectors may be upgraded at step 450. Upgrading a collector involves disconnecting a collector from a load balancer, emptying the queue of the collector, and providing a new collector. More detail for upgrading one or more collectors is discussed with respect to the method of FIG. 7.

FIG. 5 is a method for upgrading an aggregator. The method of FIG. 5 provides more detail for step 445 of the method of FIG. 4. Metrics may be transmitted to the current aggregators at step 505. The metrics may be sent by one or more collectors based on the metric being transmitted. For example, the metric may be transmitted to a particular aggregator based on a hash of the metric.

One or more upgraded aggregators may be generated at step 510. The generated aggregators may include a newer version of aggregators for use with the system of FIG. 3 and may be intended to replace an older version of aggregators.

A new aggregator start time may be set for the new aggregators at step 515. Eventually, metric data received by a collector and having a time stamp after the set start time will be routed to an aggregator of the new aggregators (e.g., the second version of aggregators). The new aggregator information may be stored in memory at step 520. The information for the new aggregators may include aggregator hash ranges to be handled, address information for the aggregator, start time, version information, and other data. The information may be accessible and provided to one or more collectors from the memory location.

The collectors receive the new version information, new aggregator information, new aggregator start time, and other data as needed at step 525. In some instances, the collectors listen for changes to the aggregator information and retrieve the information upon detecting an update. In some instances, when aggregator data is updated, the updated version, aggregator information, and aggregator start time may be pushed to the collectors.

A determination is then made as to whether the new aggregator should receive metrics at step 530. The new aggregators will receive metrics when the start time arrives. Until then, metrics are provided to the previous version of aggregators. At the time of the new aggregator start time, the new aggregators may be installed to the system (if not already done so) and may start to receive metric sets from collectors at step 535.

Metrics having a time stamp after the new aggregator start time are transmitted to the new aggregators at step 540. These metrics are received, aggregated and forwarded by the new version of aggregator.

A determination is made as to whether a received metric has a time stamp prior to the new aggregator start time at step 545. If metrics are not received with a time stamp prior to the start time, the method of FIG. 5 returns to step 540. If a received metric has a time stamp prior to the new aggregator time, then the metric is intended for the prior version of aggregator and a determination is made as to whether a grace period has expired at step 550. Once new aggregators are installed, metrics with time stamps prior to the new aggregator start time, and intended to be sent to the prior version of aggregators, may still be sent to the prior version of aggregators for a limited period of time (the grace period). If the grace period has not expired, the metrics with a time stamp prior to the new aggregator start time may be transmitted to the previous aggregator as appropriate at step 560 and the method returns to step 540. If the grace period has expired at step 550, then the metric with a time stamp prior to the new aggregator start time is ignored at step 555 and the method returns to step 540.

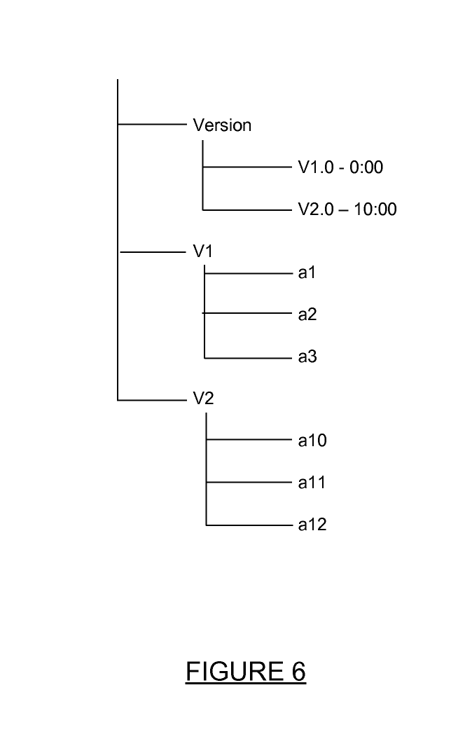

FIG. 6 is an illustration of a hierarchical tree with version and aggregator information. The aggregator tree includes first hierarchical nodes of version type, V1, and V2. The version type node may include child nodes of a first version and first version start time and second version and second version start time. When a system is first initiated, a first version will have a default time of zero. When a new set of aggregators corresponding to an upgrade is introduced into the system, a second child node will be added to the version type. The second child node will have data name of version 2 (“V2”) and will include a start time to indicate when metrics should be sent to the new version. In FIG. 6, the start time of the illustrated version V2 is 10:00.

The node V1 includes a list of aggregators associated with that version—A1, A2, A3. The aggregator names and their addresses or location information is included within the version 1 subnodes. When an upgrade occurs, a version 2 node is added with subnodes of aggregator a10, a11, and a12. Similarly, location information and hash information associated with each aggregator of version 2 is also provided.

The information of the version and aggregator tree of FIG. 6, including version start time, version information, and aggregator information including address of the aggregator, may be provided to collectors based on a collector request or pushing to the collectors when new version information is added to the tree.

FIG. 7 provides a method for upgrading a collector. The method of FIG. 7 provides more detail for step 455 of the method of FIG. 4. First, a collector connection to a load balancer is disconnected at step 710. This enables a collector which will be brought out of service to stop receiving additional payloads to process. Payloads in the queue of the collector are processed at step 720. This continues until the collector has no further payloads to process. A new collector is then created at step 730 and the old collector is removed. The new collector is registered with a load balancer at step 740. Registering the collector with a load balancer ensures that the collector may receive payloads from the load balancer. Aggregator version and aggregator addresses may then be retrieved from memory by the newly created collector at step 750. With the aggregator version and addresses, the collector may be configured with this information at step 760 and determine where to send payloads based on the data in the payloads.

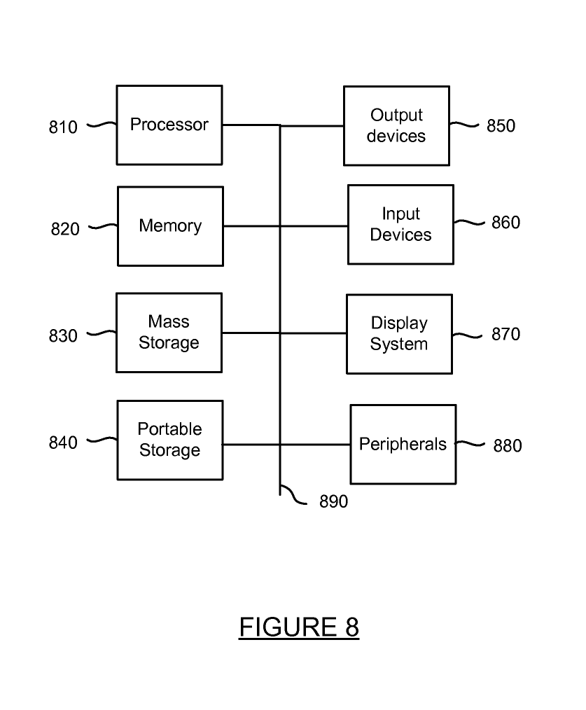

FIG. 8 is a block diagram of a computer system for implementing the present technology. System 800 of FIG. 8 may be implemented in the contexts of the likes of client 110, network server 130, application servers 140-160, collectors 170 and aggregators 180. A system similar to that in FIG. 8 may be used to implement a mobile device, such as a smart phone that provides client 110, but may include additional components such as an antenna, additional microphones, and other components typically found in mobile devices such as a smart phone or tablet computer.

The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Examples of suitable output devices include speakers, printers, network interfaces, and monitors.

Display system 870 may include an LED display, liquid crystal display (LCD) or other suitable display device. Display system 870 receives textual and graphical information, and processes the information for output to the display device.

Peripherals 880 may include any type of computer support device to add additional functionality to the computer system. For example, peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

When implementing a mobile device such as smart phone or tablet computer, the computer system 800 of FIG. 8 may include one or more antennas, radios, and other circuitry for communicating over wireless signals, such as for example communication using Wi-Fi, cellular, or other wireless signals.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for processing metrics, comprising:
transmitting by a collector module stored in memory and executed by a processor a data set to one of a first group of aggregators;
providing a plurality of updated aggregators concurrently with the first group of aggregators;
transmitting subsequent data sets to one of the aggregators in the first group of aggregators or an aggregator of the updated aggregators during a first time period; and
transmitting subsequent data sets to the updated aggregators during a second time period, the second time period occurring after the first time period.

2. The method of claim 1, wherein the data sets are provided to a particular aggregator based on a hash of the data set.

3. The method of claim 1, further comprising:
receiving a payload which includes sets of data; and
aggregating received metrics by each of a plurality of aggregators;

4. The method of claim 1, the updated aggregators associated with a start time, the subsequent data sets associated with a time stamp after the start time being transmitted to an aggregator of the updated aggregators.

5. The method of claim 1, wherein data sets received after the start time and having a time stamp within the first time period being transmitted to one of the aggregators in the first group of aggregators.

6. The method of claim 1, wherein data sets received after the start time and having a time stamp after the first time period are not transmitted to the first group of aggregators or the updated aggregators.

7. The method of claim 1, wherein the data sets are received from one or more collectors, the collectors receiving the start time and addresses of the updated aggregators from memory.

8. The method of claim 1, wherein the first group of aggregators is associated with a first version of aggregators and the updated aggregators are associated with a second version of aggregators.

9. A non-transitory computer readable storage medium having embodied thereon a program, the program being executable by a processor to perform a method for processing metrics, the method comprising:
transmitting a data set to one of a first group of aggregators;
providing a plurality of updated aggregators concurrently with the first group of aggregators;
transmitting subsequent data sets to one of the aggregators in the first group of aggregators or an aggregator of the updated aggregators during a first time period; and
transmitting subsequent data sets to the updated aggregators during a second time period, the second time period occurring after the first time period.

10. The non-transitory computer readable storage medium of claim 9, wherein the data sets are provided to a particular aggregator based on a hash of the data set.

11. The non-transitory computer readable storage medium of claim 9, further comprising:
receiving a payload which includes sets of data;
aggregating received metrics by each of a plurality of aggregators.

12. The non-transitory computer readable storage medium of claim 9, the updated aggregators associated with a start time, the subsequent data sets associated with a time stamp after the start time being transmitted to an aggregator of the updated aggregators.

13. The non-transitory computer readable storage medium of claim 9, wherein data sets received after the start time and having a time stamp within the first time period being transmitted to one of the aggregators in the first group of aggregators.

14. The non-transitory computer readable storage medium of claim 9, wherein data sets received after the start time and having a time stamp after the first time period are not transmitted to the first group of aggregators or the updated aggregators.

15. The non-transitory computer readable storage medium of claim 9, wherein the data sets are received from one or more collectors, the collectors receiving the start time and addresses of the updated aggregators from memory.

16. The non-transitory computer readable storage medium of claim 9, wherein the first group of aggregators is associated with a first version of aggregators and the updated aggregators are associated with a second version of aggregators.

17. A system for processing metrics, comprising:
a processor;
a memory; and
one or more modules stored in memory and executable by a processor to transmit a data set to one of a first group of aggregators, provide a plurality of updated aggregators concurrently with the first group of aggregators, transmit subsequent data sets to one of the aggregators in the first group of aggregators or an aggregator of the updated aggregators during a first time period, and transmit subsequent data sets to the updated aggregators during a second time period, the second time period occurring after the first time period.

18. The system of claim 17, wherein the data sets are provided to a particular aggregator based on a hash of the data set.

19. The system of claim 17, the one or more modules further executable to receive a payload which includes sets of data and aggregate received metrics by each of a plurality of aggregators;

20. The system of claim 17, the updated aggregators associated with a start time, the subsequent data sets associated with a time stamp after the start time being transmitted to an aggregator of the updated aggregators.

21. The system of claim 17, wherein data sets received after the start time and having a time stamp within the first time period being transmitted to one of the aggregators in the first group of aggregators.

22. The system of claim 17, wherein data sets received after the start time and having a time stamp after the first time period are not transmitted to the first group of aggregators or the updated aggregators.

23. The system of claim 17, wherein the data sets are received from one or more collectors, the collectors receiving the start time and addresses of the updated aggregators from memory.

24. The system of claim 17, wherein the first group of aggregators is associated with a first version of aggregators and the updated aggregators are associated with a second version of aggregators.
